(19) United States
(12) Patent Application Publication
(10) Pub. No.: US 2005/0071209 A1
(43) Pub. Date: Mar. 31, 2005

(54) Binding a workflow engine to a data model

(75) Inventors: Paul-Vlad Tatavu, North York (CA); Andrew Niel Trossman, North York (CA)

Correspondence Address: David R. Irvin;IBM Corporation T81/503, PO Box 12195, Research Triangle Park, NC, 27709, US

(73) Assignee: International Business Machines Corporation, Armonk, NY (US)

(21) Appl. No.: 10/821,076

(22) Filed: Apr. 8, 2004

(30) Foreign Application Priority Data
Sep. 26, 2003 (CA) 2442796

(51) Int. Cl. G06F 17/60

(52) U.S. Cl. 705/7

(57) ABSTRACT

A method, system and program product for more effectively managing the operational complexity of computerized data processing systems using an aspect oriented technique of binding a workflow engine to a data model representing the real environment is provided. The late binding aspect of the workflow provides more effective resource selection and allows for linking to differing workflows in accordance with the data model. Further results provided by the completed workflow may also be used to augment the data model thereby assuring a more current and consistent representation is found in the data model. A synchronization aspect if provided by the workflow result being used to then synchronize the data model with the physical resources manipulated by the workflow.

### FIELD OF THE INVENTION

This present invention relates generally to workflow management in a computer system and more particularly to binding of a workflow engine to a data model in a computer system.

### BACKGROUND OF THE INVENTION

Typical operation of computerized data processing systems has evolved to find varying solutions to managing the complexity of such systems. Automation has been introduced to relieve operators of repetitive tasks and to increase operator productivity while reducing errors caused by manual actions. The process is managed by computer that assigns work, distributes that work and tracks the progress to completion. One form of such automation has been the introduction of workflows or scripts that are designed to address operational actions and in many cases mimic the responses provided by real operators. Creation and use of such workflows has not been easy as the complex issues involved in managing many such data centre tasks has proved to be very difficult and error prone. Many early examples of computerized workflow were copies of the same manual process used before.

Complexity appeared to be the root problem to be solved and managing that complexity with workflows or scripts has meant the introduction and use of complex workflows or scripts themselves. In many cases the actual implementation of workflows was overwhelmed by the complexity of the infrastructure. In attempting to replace manual processes with computerized processes no process related changes were typically introduced. New tools were needed to improve the process itself or the management of the process.

Structured programming techniques have also been applied to address the problem of complex scenario management. Early cases were able to resolve the initial process management issues much in line with the concept of “low hanging fruit”. As larger management issues were faced, dealing with more and more resources and combinations of events, this form of programming proved to be ineffective and too inflexible as it was lacking in capabilities when compared to workflows.

Therefore what is required is a more effective way to manage the operational complexity of computerized data processing systems.

### SUMMARY OF THE INVENTION

A method, system and program product for binding a workflow engine to a data model representing the real environment is provided. The binding of the workflow engine provides more effective resource selection and flexibility by allowing linking to differing workflows in accordance with the data model. Further results provided by the completed workflow may also be used to augment the data model thereby assuring a more current and consistent representation is found in the data model. Workflow results are therefore used to synchronize the data model with the physical environment modified through workflow requests.

In one aspect of the present invention, there is provided a method for binding of a workflow engine to a data model containing data objects associated with a plurality of resources for a workflow request having a first message type in a computer system, said method comprising the steps of: updating said workflow request with pre-process workflow data; transforming said updated workflow request from first message type to a second message type supported by said workflow engine; processing said updated workflow request to update said plurality of resources in said computer system; and, updating said data objects of said data model associated with updated said plurality of resources.

In another aspect of the present invention, there is provided a computer system for binding of a workflow engine to a data model containing data objects associated with a plurality of resources for a workflow request having a first message type in a computer system, said computer system comprising: first updating means to update said workflow request with pre-process workflow data; transforming means to transform said updated workflow request from first message type to a second message type supported by said workflow engine; processing means to process said updated workflow request to update said plurality of resources in said computer system; and, second updating means to update said data objects of said data model associated with updated said plurality of resources.

In another aspect of the present invention there is provided a computer program product having a computer readable medium tangibly embodying computer readable program code for instructing a computer to perform the method for binding of a workflow engine to a data model containing data objects associated with a plurality of resources for a workflow request having a first message type in a computer system, said method comprising the steps of: updating said workflow request with a pre-process workflow data; transforming said updated workflow request from first message type to a second message type supported by said workflow engine; processing said updated workflow request to update said plurality of resources in said computer system; and, updating said data objects of said data model associated with updated said plurality of resources.

In yet another aspect of the present invention there is provided a signal bearing medium having a computer readable signal tangibly embodying computer readable program code for instructing a computer to perform a method for binding of a workflow engine to a data model containing data objects associated with a plurality of resources for a workflow request having a first message type in a computer system, said method comprising the steps of: updating said workflow request with pre-process workflow data; transforming said updated workflow request from first message type to a second message type supported by said workflow engine; processing said updated workflow request to update said plurality of resources in said computer system; and, updating said data objects of said data model associated with updated said plurality of resources.

In another aspect of the present invention there is provided a computer program product having a computer readable medium tangibly embodying computer readable program code for instructing a computer system to perform the means for binding of a workflow engine to a data model containing data objects associated with a plurality of resources for a workflow request having a first message type in a computer system, said computer system comprising: first updating means to update said workflow request with pre-process workflow data; transforming means to transform said updated workflow request from first message type to a second message type supported by said workflow engine; processing means to process said updated workflow request to update said plurality of resources in said computer system; and, second updating means to update said data objects of said data model associated with updated said plurality of resources.

In another aspect of the present invention there is provided a signal bearing medium having a computer readable signal tangibly embodying computer readable program code for instructing a computer to perform the means for binding of a workflow engine to a data model containing data objects associated with a plurality of resources for a workflow request having a first message type in a computer system, said computer system comprising: first updating means to update said workflow request with pre-process workflow data; transforming means to transform said updated workflow request from first message type to a second message type supported by said workflow engine; processing means to process said updated workflow request to update said plurality of resources in said computer system; and, second updating means to update said data objects of said data model associated with updated said plurality of resources.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Preferred embodiments of the invention will now be described, by way of example, with reference to the accompanying drawings, in which:

FIG. 1 is a hardware overview of a computer system, in support of an embodiment of the present invention;

FIG. 2 is a block diagram of components in an embodiment of the present invention as supported in the computer system of FIG. 1;

FIG. 3 is a flow diagram of determining a workflow in an embodiment of the present invention;

Like reference numerals refer to corresponding components and steps throughout the drawings. It is to be expressly understood that the description and the drawings are only for the purpose of illustration and as an aid to understanding, and are not intended as a definition of the limits of the invention.

### DETAILED DESCRIPTION

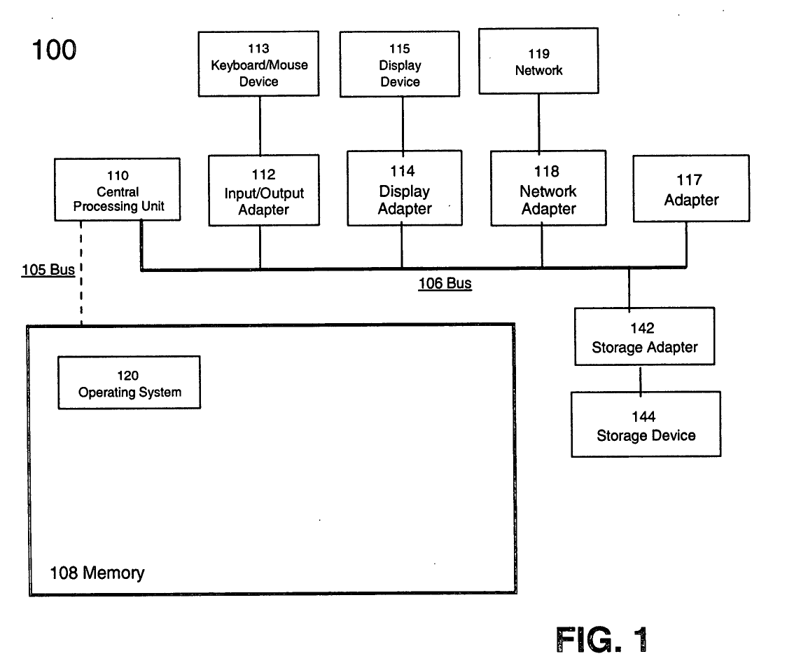

FIG. 1 depicts, in a simplified block diagram, a computer system 100 suitable for implementing embodiments of the present invention. Computer system 100 has processor 110, which is a programmable processor for executing programmed instructions stored in memory 108. Memory 108 can also include hard disk, tape or other storage media. While a single CPU is depicted in FIG. 1, it is understood that other forms of computer systems can be used to implement the invention. It is also appreciated that the present invention can be implemented in a distributed computing environment having a plurality of computers communicating via a suitable network 119.

CPU 110 is connected to memory 108 either through a dedicated system bus 105 and/or a general system bus 106. Memory 108 can be a random access semiconductor memory for storing application data for processing such as that in a database partition. Memory 108 is depicted conceptually as a single monolithic entity but it is well known that memory 108 can be arranged in a hierarchy of caches and other memory devices. FIG. 1 illustrates that operating system 120 may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement selective program tracing functions such as gathering trace records and historical data as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM, although other types of data storage devices can be used, including removable media.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server that can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

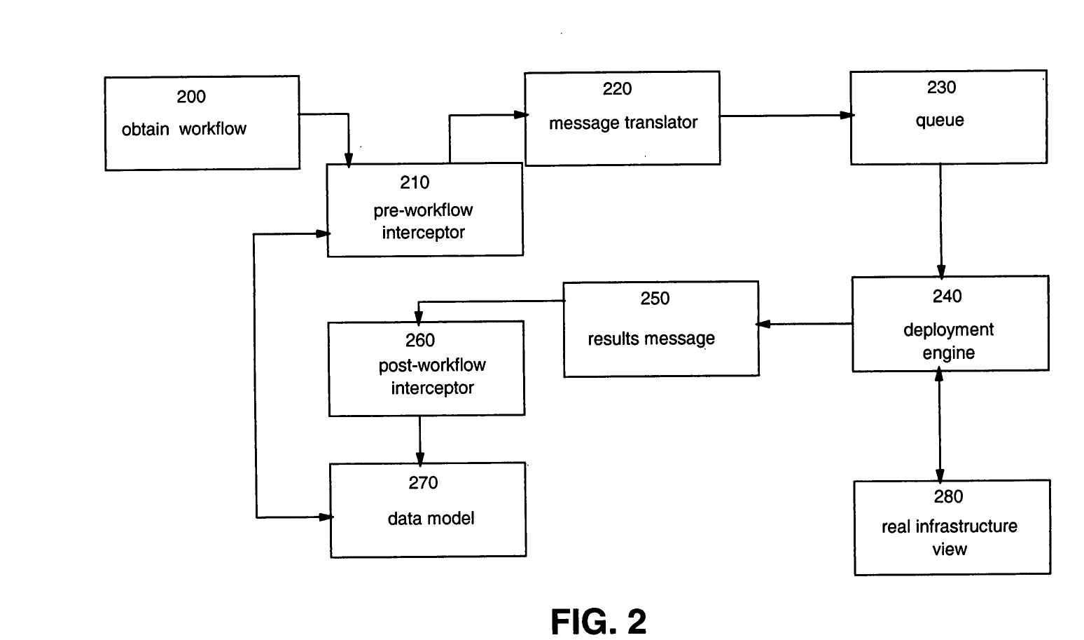

FIG. 2 is a simplified view of the logical relationship between the software components of an embodiment of the present invention. Receiving front end 200 may be advantageously implemented as a SOAP style interface within a web services component allowing a broad range of access to requesters of workflow. Other means of implementing such an access point may be used as well as is known in the art. Pre-workflow interceptor 210 catches incoming workflow requests to allow pre-processing to be performed as needed. Pre-processing includes substitution of workflow data by data from other sources such as data objects held in data model 270. Interceptor 210 may be invoked externally through request from other components or internally by way of the executing workflow as it initiates a sub-workflow which is another workflow itself. Message translator 220 provides transformation services between various supported message formats. The message output is used to actually commence a workflow. Queue 230 is used to contain workflows scheduled for execution providing a staging or holding place. Deployment engine 240 performs the actual workflow execution. Results of the workflow being run in deployment engine 240 are provided in the form of results message 250. Post-workflow interceptor 260 catches the resulting messages or outcome notification from deployment engine 240 processing to allow for any additional processing to occur. Finally data model 270 is updated with results of processing workflow by post-workflow interceptor 260 to include any updates specified in the logical operations of the workflow. The updating performed keeps the data model synchronized with actual real infrastructure view 280. If the workflow processing was unsuccessful, then post-workflow interceptor 260 would simply perform cleanup activities to remove any partially updated data objects as necessary. Pre-workflow interceptor 210 could be used to disable monitoring of devices scheduled to be updated by a workflow. In this case the execution of the workflow would not cause any unnecessary alerts as monitoring for those specific devices would have been disabled. Similarly post-workflow interceptor 260 would have been use to enable monitoring of the devices, for which monitoring was disabled, after completion of the workflow execution. Real infrastructure view 280 is the actual view of the infrastructure associated with the complex being managed. Real infrastructure view 280 may contain data for hardware and software implementations.

Synchronization of real infrastructure view 280 and data model 270 is performed routinely by post-workflow interceptor 260 removing the burden of this activity from the actual workflow. Having synchronized real infrastructure view 280 and data model 270, workflows can now leverage data contained in data model 270 through pre-workflow interceptor 210 providing added simplification for workflow designers.

Deployment engine 240 has been enabled to process and invoke logical operations contained within workflows. This enablement allows workflows to be further adapted to data model 270. As a result, workflows may be structured to include multiple logical operations, each of which can invoke a different sub-workflow depending upon data model 270. This then mimics the object-oriented approach toward workflow development. Further the late binding to the workflow of information in data model 270 allows the workflow to link to other workflows in accordance with the data in data model 270.

In an example implementation of an embodiment of the present invention using a Java environment, enterprise Java beans may be used to comprise the interceptor layer. A stateless session bean may then be used for pre-workflow interceptor 210 with a message driven bean being used for post-workflow interceptor 260. The entry point for receiving requests through a SOAP interface may be implemented as the stateless session bean (as in pre-workflow interceptor 210) and be exposed over web services description language (WSDL) to appeal to a broad array of potential users.

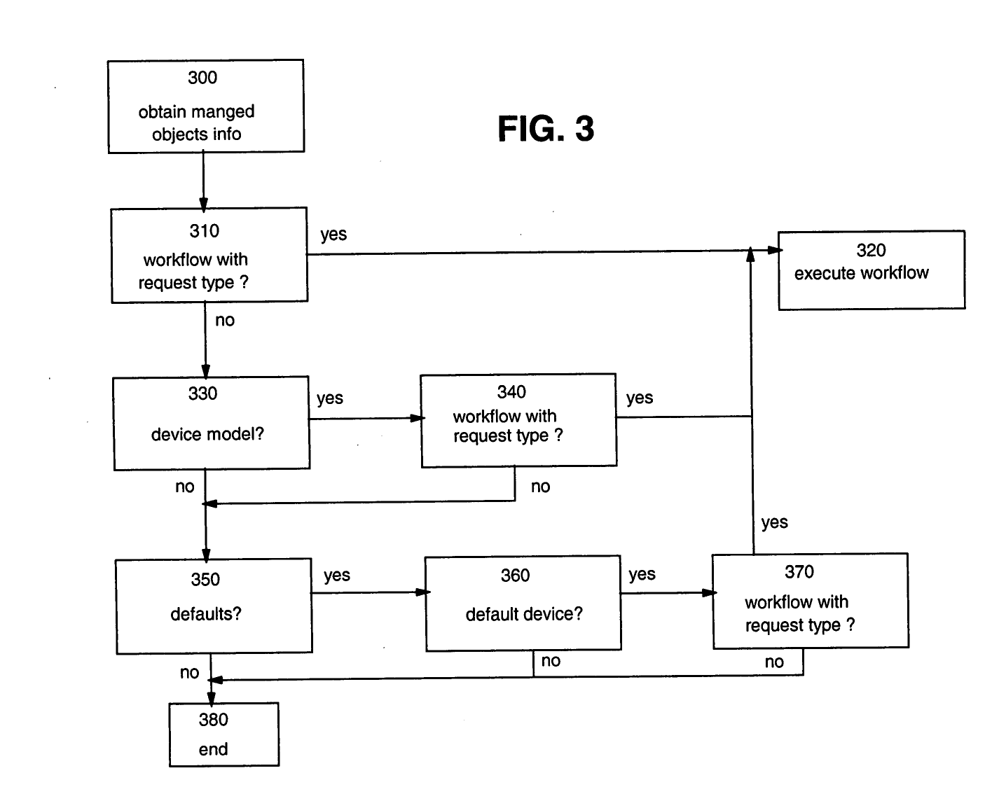

FIG. 3 is a flow diagram of an embodiment of the present invention showing detail of pre-workflow interceptor 210 of FIG. 2 determining a workflow. Pre-workflow interceptor 210 of FIG. 2 is used in the example to resolve a workflow prior to execution. During operation 300 necessary data centre model objects are made available from a metadata repository (the data centre model) to be used throughout further processing by pre-workflow interceptor 210. The metadata repository contains a plurality of identified objects describing or representing the data centre resources to be managed by the associated workflows. The tertiary association of metadata objects corresponding to logical operations with various data centre model objects identified and their device models and workflows, for example, then allow resolution of any logical operation with a data centre model identifier to a workflow. The general flow is to traverse a search hierarchy of workflow requests, device models and defaults as described in the following.

During operation 310 a determination is made with regards to the workflow and associated request types. Request types are the logical operations contained within the workflow being requested. These are enumerated and provide a quick way to indicate what resources and actions are intended for use by the workflow. If the requests types are found, the workflow is ready for execution and the flow moves to operation 320 where the workflow is then executed to completion. Otherwise, having not found request types, processing moves to operation 330.

During operation 330 device model 270 is queried for appropriate device information to be used by the workflow. If successful, processing moves to operation 340 where the workflow is again queried for request types. If this query is satisfied, processing then moves to operation 320 where the workflow is executed as before. The workflow is queried to determine if changes have been made due to late binding with the data model to satisfy information related to request types or other pre-workflow processing that may have occurred. If on the other hand, lookup in device model 270 did not provide a favourable response, processing would move to operation 350.

During operation 350 a determination is made with regard to default specifications for processing of the requested workflow. If default is specified then processing moves to operation 360 during which a default device specification will be examined to determine if it meets the needs of the workflow. If the default device specification can satisfy the workflow request, then processing moves to operation 370 where again the requested workflow is queried for appropriate request type information. If the request type information is available in keeping with the default device specifications then processing moves to operation 320 where the workflow is then executed as before.

If the determination made during operation 350 resulted in no defaults specified the workflow would have been stopped as the processing would move to end at operation 380, during which any necessary cleanup of resources would have been performed. Similarly if during operation 360 no default device could be selected or made available, then processing would have moved to end at operation 380. Also if during operation 370 no request type information could be obtained in conjunction with a default device specification, then that result would cause processing to move to end at operation 380 as before.

Having successfully identified the workflow, the workflow may be executed during operation 320 by calling the workflow engine shown as deployment engine 240 of FIG. 2.

Pre-processing of the workflow eliminates the need to manage conditions during the workflow itself. For example, a workflow may require the operation of a server at a specific IP address. Prior to execution pre-workflow interceptor 210 would intercept the workflow request, and act upon the conditional process requirement by delegating to a typical availability monitor to determine if the server is available. If the server was not available, the workflow would not be executed and the request would fail. Otherwise, knowing the server was available the workflow would be safely executed without server availability concerns. No extra checking is required during the workflow processing due to the separation of the task from the workflow. This separation makes the creation of workflows simpler

Although the invention has been described with reference to illustrative embodiments, it is to be understood that the invention is not limited to these precise embodiments and that various changes and modifications may be effected therein by one skilled in the art. All such changes and modifications are intended to be encompassed in the appended claims.

1. A method for binding of a workflow engine to a data model containing data objects associated with a plurality of resources, for a workflow request having a first message type in a computer system, said method comprising the steps of:
updating said workflow request with pre-process workflow data;
transforming said updated workflow request from first message type to a second message type supported by said workflow engine;
processing said updated workflow request to update said plurality of resources in said computer system; and,
updating said data objects of said data model associated with updated said plurality of resources.

2. The method of claim 1, wherein the step of updating said workflow request further comprises:
determining a plurality of request types associated with said workflow request; and
resolving said plurality of request types based on said data objects of said data model.

3. The method of claim 2 wherein said step of resolving further comprises:
matching logical operations associated with said plurality of request types with corresponding said data objects identified in said data model; and,
substituting corresponding said data objects representative of said pre-process workflow data into said workflow request.

4. The method of claim 3, wherein the step of resolving further comprises traversing a search hierarchy including said workflow request, a device model and a defaults objects.

5. The method of claim 1 wherein said step of processing said updated workflow request further comprises a workflow engine.

6. The method of claim 5 wherein the step of updating said data model further comprises:
sending outcome data in notification of said workflow processed from said workflow engine to a post workflow interceptor;
matching said outcome data in said notification with corresponding data objects in said data model by said post-workflow interceptor; and
updating of said data objects in said data model with said outcome data by said post-workflow interceptor to synchronize said data model with said plurality of resources of said computer system.

7. A computer system for binding of a workflow engine to a data model containing data objects associated with a plurality of resources for a workflow request having a first message type in a computer system, said computer system comprising:
first updating means to update said workflow request with pre-process workflow data;
transforming means to transform said updated workflow request from first message type to a second message type supported by said workflow engine;
processing means to process said updated workflow request to update said plurality of resources in said computer system; and,
second updating means to update said data objects of said data model associated with updated said plurality of resources.

8. The system of claim 7, wherein said first update means further comprises:
determining means to determine a plurality of request types associated with said workflow request; and
resolving means to resolve said plurality of request types with said data model.

9. The system of claim 8, wherein said resolving means further comprises:
matching means to match logical operations associated with said plurality of request types with corresponding data objects in said data model; and,
substitution means for substituting said corresponding data objects representative of pre-process workflow into said workflow request.

10. The system of claim 9, wherein said resolving means further comprises: means for traversing a search hierarchy of objects including said workflow request, a device model and a defaults object.

11. The system of claim 10 wherein said processing means further comprises a workflow engine.

12. The system of claim 11 wherein said second update means further comprises:
sending means to send outcome notification of said workflow processing from said deployment engine to a post workflow interceptor;
match means for matching results of said workflow request contained in said outcome notification with corresponding said data objects in said data model by said post-workflow interceptor; and
synchronize means for updating said data model with said match results by said post-workflow interceptor to synchronize said data model with said plurality of resources of said computer system.

13. A computer program product having a computer readable medium tangibly embodying computer readable program code for instructing a computer to perform the method of any of claims 1 to 6.

14. A signal bearing medium having a computer readable signal tangibly embodying computer readable program code for instructing a computer to perform the method of any of claims 1 to 6.

15. A computer program product having a computer readable medium tangibly embodying computer readable program code for instructing a computer to perform the means of any of claims 7 to 12.

16. A signal bearing medium having a computer readable signal tangibly embodying computer readable program code for instructing a computer to perform the means of any of claims 7 to 12.
